(19) United States
(12) Patent Application Publication
(10) Pub. No.: US 2010/0247276 A1
(43) Pub. Date: Sep. 30, 2010

(54) Keg lifting device

(76) Inventor: Giuseppe Loria, Warwick, PA (US)

Correspondence Address: Armand M. Vozzo, Jr., 19 Short Road, Doylestown, PA, 18901, US

(21) Appl. No.: 12/383,684

(22) Filed: Mar. 27, 2009

(51) Int. Cl. B66F 11/00; B66F 3/00; B62B 3/00; B66F 9/02; B66F 19/00; B65G 67/04

(52) U.S. Cl. 414/373; 254/113; 280/47.34

(57) ABSTRACT

An improved lifting device and associated system for handling a standard beverage keg comprises a rigid support frame formed to partially surround a standing keg and including a pair of vertical posts spaced apart and interconnected by separate upper and lower transverse beams, the posts being erected and supported upon respective lateral base beams that extend forward and rearward of the posts with a support brace angularly disposed and secured over each forward beam extension. A lever rod is pivotally connected to the upper transverse beam having a lower handle end and an upper working end carrying a bifurcated chain link attached thereto, the bifurcated chain link holding a pair of hook fasteners sized and shaped to fit the hand holds provided on the upper rim of the standard keg. With the support frame placed alongside the standing keg and the working end of the lever rod directly over the keg, the hook fasteners are made to engage the hand holds on opposite sides of the keg and apply a clamping pressure to the keg upon lifting. A deployable extension chain further provided on the support frame is adapted to fasten to the handle end of the lever rod to hold the lifted position of the keg, allowing a dolly with a circularly formed raised surface layer to engage the bottom of the keg for its immediate transport.

### BACKGROUND OF THE INVENTION

The present invention relates to devices for lifting and moving heavy or bulky objects, and more particularly to an improved device for lifting a standard beverage keg to facilitate its immediate transport within a confined area.

In the commercial distribution of beverages, large generally cylindrical containers, commonly called kegs, are used to store, transport and serve beer, soda and other beverages. Keg sizes and shapes are standardized so that the keg can be used as a standard unit of measure for liquid volumes, typically in U.S. gallons or metric liters. In the U.S., for instance, a “full keg” customarily holds 15.5 gallons of a beverage and weighs in excess of 160 pounds. Although constructed from a lightweight material, typically aluminum, and having a somewhat compact cylindrical appearance, a full keg or even a half-sized version filled with beer or other beverage can be a physically demanding and potentially hazardous task to lift and move around a restaurant, bar or other commercial establishment through crowded area and tight spaces to where the keg is tapped and its beverage contents dispensed.

The Occupational Safety and Health Administration (OSHA) of the U.S. Department of Labor on its website (www.osha.gov) acknowledges the physically demanding tasks of lifting and transporting full kegs of beer and recognizes the increased risks of pain and injury to workers, particularly to their lower back, from the frequent torso bending normally involved. OSHA recommends using two workers whenever possible to lift full kegs manually and further using the assist of mechanical devices to transport the kegs to their particular service location. One such mechanical device shown on the OSHA website is a clamping device that connects axially to the keg allowing the cylindrical body of the keg to roll on the surface of the ground behind the worker as it is pulled in the direction of transport. Other available mechanical means for transporting full kegs include wheeled devices such as hand trucks, hand carts and dollies. Examples of these keg transport devices are found shown and described in U.S. Pat. No. 6,086,310 to Lujan, III et al. (hand truck version), Des. 381,171 (keg dolly) and in U.S. Patent Pub. No. US 2002/0187027 (hand cart).

While these and other prior art devices have generally performed well in transporting full kegs through relatively open areas along ground levels, they have evidenced certain limitations in their ability to maneuver safely and easily through tight spaces and behind bar counters at the site where customers are served. Problems have also been presented with some of these keg transport devices due to difficulties experienced by the user in manipulating the structural elements provided on the devices for engaging and holding the keg in a stabilized position for transport. In addition, there are no known prior art devices that effectively raise a full keg directly from the ground at its delivery site to safely load the keg for immediate transport without need for rolling or tilting of the keg and the associated risk of damage caused thereby.

### SUMMARY OF THE INVENTION

Accordingly, it is a general purpose and object of the present invention to provide an improved keg handling system to lift and transport full kegs of beverages in and around commercial establishments with greater ease and reduced risks of physical injury.

A more particular object of the present invention is to provide an improved keg handling system that will assist the user in manually lifting a full keg with reduced physical effort and pain so that the keg can be transported through a commercial site to a dispensing location in a safe and effective manner.

Another object of the present invention is to provide an improved device capable of lifting a full keg upon delivery for immediate transport to a dispensing location that is safe and easy to use and that can be operated effectively at a variety of locations.

Still another object of the present invention is to provide a keg lifting device that is portable and capable of being implemented at any standing location where a full keg may be delivered or stored.

A still further object of the present invention is to provide an improved keg lifting device that is easy and inexpensive to manufacture, durable in its construction and reliable in its performance.

Briefly, these and other objects of the present invention are accomplished by an improved lifting device and associated system for handling a standard beverage keg so that a full keg may be moved from a standing location where delivered or stored to a desired service location where tapped and served. The keg lifting device comprises a rigid support frame formed to partially surround the standing keg and including a pair of vertical posts spaced apart and interconnected by separate upper and lower transverse beams, the posts being erected and supported upon respective lateral base beams that extend forward and rearward of the posts with a support brace angularly disposed and secured over each forward beam extension. A lever rod is pivotally connected to the upper transverse beam having a lower handle end and an upper working end carrying a bifurcated chain link attached thereto, the bifurcated chain link holding a pair of hook fasteners sized and shaped to fit the hand holds provided on the upper rim of the standard keg. With the support frame placed alongside the standing keg and the working end of the lever rod directly over the keg, the hook fasteners are made to engage the hand holds on opposite sides of the keg and apply a clamping pressure when downward force is applied at the handle end. A deployable extension chain further provided on the support frame is adapted to fasten to the handle end of the lever rod to hold the lifted position of the keg, allowing a dolly with a circularly formed raised surface layer to engage the bottom of the keg for its immediate transport.

For a better understanding of these and other aspects of the present invention, reference should be made to the following detailed description taken in conjunction with the accompanying drawings in which like reference numerals and character designate like parts throughout the figures thereof.

### BRIEF DESCRIPTION OF THE DRAWINGS

For a fuller understanding of the nature and objects of the present invention, references in the detailed description set forth below shall be made to the accompanying drawings in which:

FIG. 1 is a front perspective view of a preferred embodiment of a keg lifting device constructed in accordance with the present invention and shown operatively disposed about a standing beverage keg appearing in phantom outline;

FIG. 2 is a rear perspective view of the upper portion of the keg lifting device shown in FIG. 1;

FIG. 3 is a side elevation view of the keg lifting device of FIG. 1 shown in operative engagement with the standing beverage keg further in phantom outline;

FIG. 4 is a side elevation view of the keg lifting device of FIG. 1 operatively holding the beverage keg in a raised position;

FIG. 5 is a perspective view of a keg dolly preferred for use with the present keg lifting device as a means for transport in accordance with the present invention;

FIG. 6 is a side elevation view of the present keg lifting device shown in the operative position of FIG. 4 together with the keg dolly of FIG. 5 positioned beneath the raised beverage keg; and

FIG. 7 is a side elevation view of the beverage keg engaged upon the keg dolly for transport after removal from the lifting device in accordance with the present invention.

### DETAILED DESCRIPTION OF THE INVENTION

The following is a detailed description of a preferred embodiment of the present invention and the best presently contemplated mode of its production and practice. This description is further made for the purpose of illustrating the general principles of the invention but should not be taken in a limiting sense, the scope of the invention being best determined by reference to appended claims.

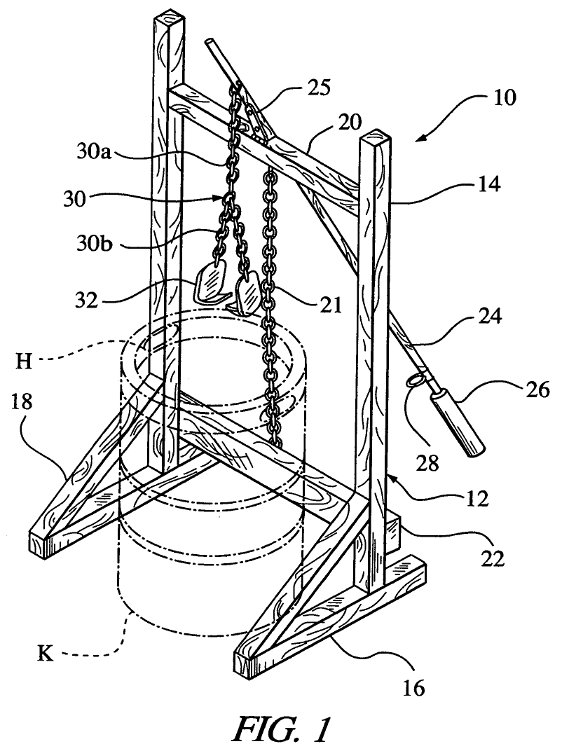

Referring now to FIG. 1, a keg lifting device, generally designated 10, is shown made in accordance with the present invention and operatively disposed about a standing beverage keg K (in phantom outline) to assist a user (not shown) in lifting and handling the keg. The present lifting device 10 is particularly suited for handling the beverage keg K depicted herein, which is of the type standardized in use and shape of construction, namely, being a substantially cylindrical container, typically constructed of aluminum, that is designed to store, transport and serve alcoholic or non-alcoholic beverages, generally under pressure. Keg sizes are further standardized according to their liquid volume capacity with the U.S. standard being a “full” keg of 15.5 U.S. gallons and a “half” keg of 7.75 gallons. Regardless of size, the beverage keg K is uniformly constructed having a raised cylindrical rim formed around the top of the keg with a pair of hand hold openings H made in the perimeter surface on opposite sides thereof. These hand holds H are uniformly provided to allow means for manually gripping the keg K for purposes of its movement.

The keg lifting device 10 comprises a rigid support frame 12 erected and formed to fit about and partially surround the standing keg K at the base of the support frame. The support frame 12 is constructed from an orthogonal assembly of members, each of a lightweight but rigid material, such as wood, plastic or aluminum stock, and includes a pair of vertical post members 14 that are spaced apart and erected upon a respective base beam 16 that is disposed perpendicularly and attached at the bottom of each post member. Each base beam 16 is made to extend perpendicularly in forward and rearward directions from its attachment at the bottom of the bottom of the respective post member 14. A brace member 18 is angularly disposed over the forward extension of each base beam 16 and secured between the lower part of each post member 14 and the front of the base beam to support the post members in their erected positions upon the base beams. The erected post members 14 are interconnected and joined by separate transverse members, an upper transverse beam 20 and a lower transverse beam 22. The upper transverse beam 20 is disposed laterally and connected between the separate post members 14 in a substantially level attitude near the top of the post members. The lower transverse beam 22 is likewise disposed laterally and secured between the separate post members 14 on a level near the bottom of the respective post members just above the rearward extension of the base beam 16 on each side of the support frame 12. The respective upper and lower transverse beams, 20 and 22, are substantially similar in lengths made sufficient to separate the erected post members 14 and their orthogonal supporting members, base beam 16 and brace member 18, spacing them apart so that the beverage keg K may fit closely therebetween in a standing position as seen in FIG. 1.

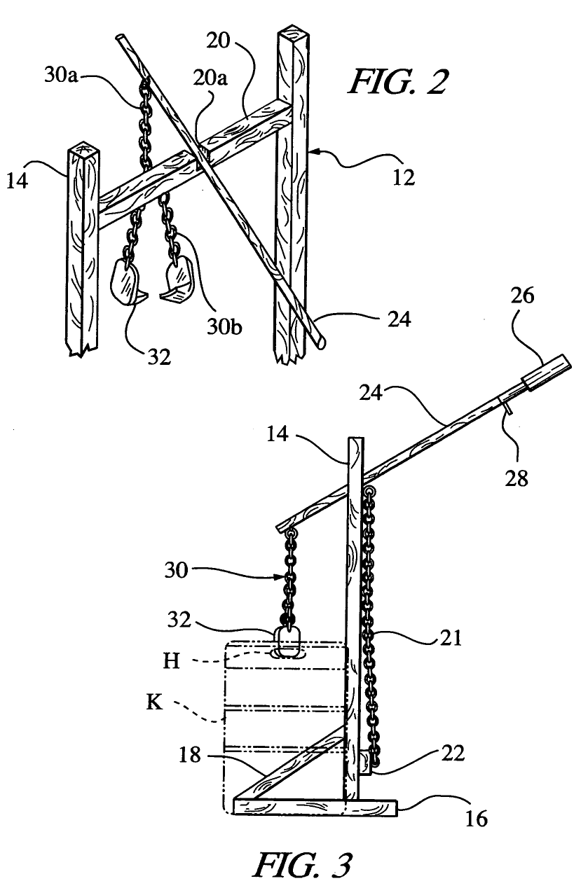

Referring now to FIG. 2 in conjunction with FIG. 1, the upper transverse beam 20 is formed with a notched section 20a centrally located along the length of the upper transverse beam between the erected post members 14 of the support frame 12. An elongated lever rod 24 formed in its transverse dimension to fit within the notched section 20a is pivotally connected along its length to the upper transverse beam 20 by means of a hinge plate 25 attached to the rod and secured to the upper transverse beam at the forward edge of the notched section. One end of the lever rod 24, referred to as the working end, is positioned forward of the upper transverse beam 20 and the pivotal connection of the hinge plate 25 so that the working end of the rod may extend over the standing position of the beverage keg K. The opposite end of the lever rod 24, referred to as the handle end, extends rearward of the upper transverse beam 20 and the erected post members 14 of the support frame 12 and is provided with a handle grip 26 attached thereto.

A chain link 30 having a bifurcated form is attached along the lever rod 24 near the working end thereof so that the bifurcated chain link may hang downward therefrom and over top of the standing position of the beverage keg K. The bifurcated chain link 30 is formed having a linear section 30a that is attached at its upper end to the lever rod 24 and adapted to hang therefrom and a bifurcated section 30b of two separate links that are assembled together and connected to the lower end of the linear section to suspend freely therefrom. A pair of hook fasteners 32, preferably made of a rigid plate material formed at a 90° angle or an angle slightly acute, are pivotably connected to the base of the respective links of the bifurcated section 30b so that the hook fasteners may each move freely about at the bottom of the bifurcated chain link 30. The hook fasteners 32 are sized to fit and shaped to engage the hand holds H on the upper rim of the beverage keg K and in their assembled positions at the base of the bifurcated chain link 30, the hook fasteners are intended to engage the respective hand holds on each side of the rim from the outer side thereof and thereby act together to clamp the keg about the upper rim when lifted. A deployable linear chain link 21 is further included upon the support frame 12 and is disposed normally between the upper transverse beam 20 and the lower transverse beam 22 on the rearward side of the support frame. Attached to the lower transverse beam 22 at the bottom of its length, the deployable chain link 21 is releasably fastened to the upper transverse beam 20 and may be removed therefrom to refasten to the handle end of the lever rod 24, the chain link being adapted to engage a hook or loop fastener 28 fixed upon the lever rod near the handle grip 26. Deployed in this refastened position, as best viewed in FIGS. 4 and 6, the chain link 21 serves to hold the lever rod 20 in a fixed attitude upon lifting the beverage keg K, allowing the user to work about the raised keg with his hands free from the rod and particularly set the position of transport dolly 40, described in greater detail below, for engagement with the raised keg.

Referring now to FIG. 3 and 4 in conjunction with FIGS. 1 and 2, the support frame 12 of the present lifting device 10 is intended to be positioned for operation alongside and immediately behind the standing beverage keg K with the forward extensions of base beams 16 tangentially positioned along those opposed sides of the keg where the hand holds H are located. With the support frame 12 in this operative position, the lever rod 24 is pivoted upon hinge plate 25, raising the handle end and lowering the working end of the rod sufficiently to allow the bifurcated link 30 and the hook fasteners 32 to reach the upper rim of the beverage keg K and the hand holds H on either side. The hook fasteners 32 are then inserted into the hand holds H, preferably from the outer side of the rim, and made to engage them with a clamping pressure applied through the bifurcated link section 30a as the chain link 30 is tensioned under the weight of beverage keg K. With the hook fasteners 32 engaged within the hand holds H and the clamping pressure thereby applied to the upper rim of keg K, the user will lower the handle end of the lever rod 24, preferably by downward force applied at the grip 26, effectively elevating the keg and allowing the elevated position to be maintained by extension of the linear chain link 21 into its deployed position, as shown in FIG. 4, connected to fastener 28 along the handle end of the lever rod 24.

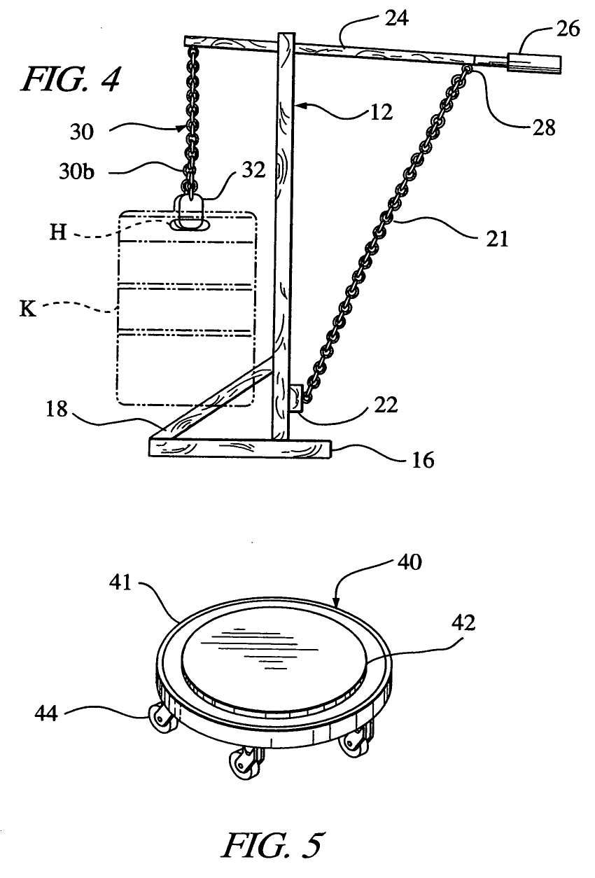

Referring now to FIG. 5, a dolly 41 for transporting the beverage keg K in accordance with the present invention comprises a cylindrical base platform 41 rigid in construction and having a circular upper surface of a diameter substantially the same as the standard outer diameter of the beverage keg K. A raised surface layer or pad 42 made in a circular form preferably from a resilient material, such as rubber or plastic, is disposed concentrically upon the base platform and attached to the upper surface thereof. The pad 42 is formed having a diameter less than that of the upper surface of the base platform 41 and substantially the same as but slightly less than the inner diameter of the circular cavity typically found formed in the bottom of the standard beverage keg K. Disposed and formed in this fashion, the pad 42 will fit into the cavity when the keg is lowered onto the dolly 40 and provide seated engagement between the dolly and the beverage keg resting thereon. A set of casters 44, at least three in number, are secured to the bottom of the base platform 41 and spaced apart radially around the perimeter thereof to permit rolling movement of the dolly 40 and provide associated rolling transport of the beverage keg K thereon.

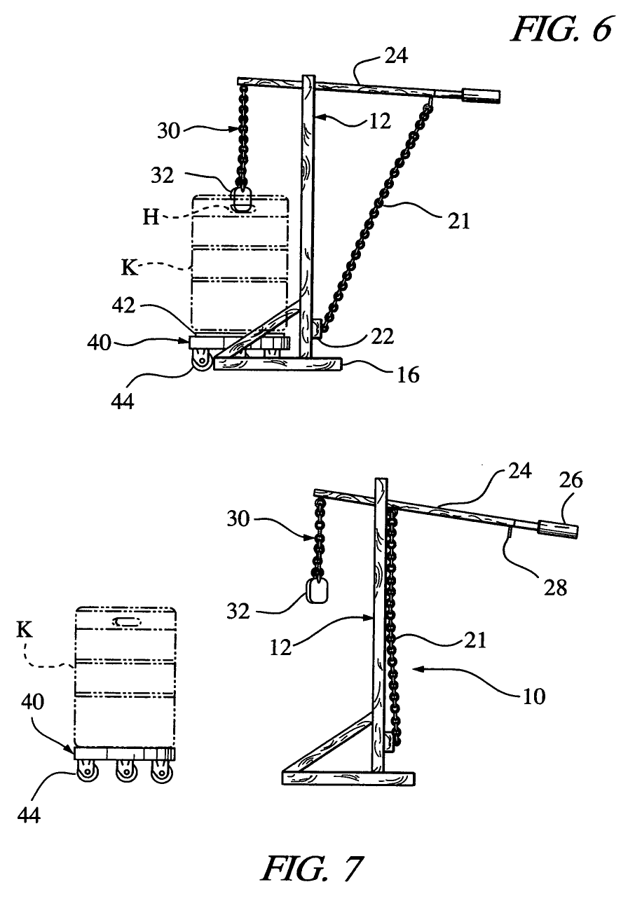

Referring now to FIGS. 6 and 7 in conjunction with FIGS. 4 and 5, with the present lifting device 10 holding the beverage keg K in the raised position shown in FIG. 4, the dolly 40 is rolled into place between the base beams 16 of support frame 12 and directly beneath the raised beverage keg, as is shown in FIG. 6. The user may then release the chain link 21 from its engagement with the handle end of the lever rod 24 and holding the grip 26 at the handle end of the lever rod, slowly lower the raised beverage keg K onto the dolly 40 and its base platform 41 so that the bottom of the beverage keg may engage the raised pad 42 on the platform and be seated thereon. Once the beverage keg K is properly seated upon the raised pad 42 of the dolly 40, the hook fasteners 32 on the bifurcated chain link 30 may be released from the hand holds H, having been loosened from the weight of the beverage keg, and the keg then transported upon the dolly 40 rolling via its casters 44 away from the support frame 12 and to its immediate destination for storage or dispensing.

Therefore, it is apparent that the described invention provides an improved keg handling system to lift and transport full kegs of beverages along ground levels, particularly in and around commercial establishments, with greater ease and reduced risks of physical injury. The present invention more particularly provides an improved keg handling system that will assist the user in manually lifting a full keg with reduced physical effort and pain so that the keg can be transported through a commercial site to a dispensing location in a safe and effective manner. The described invention further provides an improved device capable of lifting a full keg upon delivery for immediate transport to a dispensing location that is safe and easy to use and that can be operated effectively at a variety of locations. In addition, the present invention provides a keg lifting device that is portable and capable of being implemented at any standing location where a full keg may be delivered or stored. Furthermore, the present keg lifting device and associated handling system are easy and inexpensive to manufacture, durable in construction and reliable in performance.

Obviously, other embodiments and modifications of the present invention will readily come to those or ordinary skill in the art having the benefit of the teachings presented in the foregoing description and drawings. Alternate embodiments of different shapes and sizes, as well as substitution of known materials or those materials that may be developed at a future time to perform the same function as the present described embodiment are therefore considered to be part of the present invention. For example, the described orthogonal configuration and assembly of the support frame 12 with its upright posts 14, and perpendicular base beams 16 and transverse beams 20 and 22 may rather be curved in its form and rounded in its configuration about the beverage keg K being handled. Also, the elongated lever rod 24, shown and described above as a rigid member having a fixed length, may well be an adjustable member of variable length with a collapsible or telescopic longitudinal structure capable of resulting in a more compact and easier to handle device while still providing a mechanical working advantage in lifting and handling the standing beverage keg. Accordingly, it is understood that this invention is not limited to the particular embodiment described, but rather is intended to cover modifications within the spirit and scope of the present invention as expressed in the appended claims.

What is claimed:

1. A device for lifting a standing beverage keg to a raised position, the beverage keg being substantially cylindrical in form and having hand hold openings located around the upper rim thereof, comprising:
a support frame formed to fit about and partially surround the beverage keg forward of the support frame;
a lever member pivotally connected to said support frame at a hinge point elevated thereon, said lever member having a working end positioned forward of said hinge point over the beverage keg and a handle end positioned rearward of the hinge point; and
bifurcated hook means suspended from the working end of said lever member and adapted to engage the hand hold openings for applying clamping pressure upon the upper rim of the beverage keg through the hand hold openings while the beverage keg is lifted to the raised position.

2. A keg lifting device according to claim 1, further comprising:
link means connected upon said support frame and releasably engaged along the handle end of said lever member for maintaining the beverage keg in the raised position.

3. A keg lifting device according to claim 2, wherein said support frame is formed of orthogonal members comprising:
a pair of post members spaced apart and erected in respective upright positions;
a pair of base beam members each perpendicularly assembled and attached to the bottom of a respective one of said post members, said base beam members each being disposed having forward extensions from the bottom of said post members; and
a pair of transverse beam members perpendicularly assembled between said post members and spaced apart in elevation thereon, the upper transverse beam being adapted to provide the hinge point for said lever member.

4. A keg lifting device according to claim 3, wherein said link means comprises:
a length of chain link secured at one end thereof to the lower transverse frame and releasably fastened at the other end along the handle end of said lever member for holding said lever member in a fixed attitude upon lifting the beverage keg to the raised position.

5. A keg lifting device according to claim 1, wherein said bifurcated hook means comprises:
a bifurcated chain link member connected to the working end of said lever member and suspended therefrom; and
a pair of hook fasteners connected to the base of said bifurcated chain link member, said hook fasteners being sized to fit and shaped to engage the hand hold openings on the upper rim of the beverage keg.

6. A keg lifting device according to claim 5, wherein said bifurcated chain link member comprises:
a linear section coupled at the upper end thereof to said lever member and adapted to hang therefrom; and
a bifurcated section of separate links assembled together and connected to the lower end of said linear section to suspend freely therefrom.

7. A keg lifting device according to claim 6, wherein each of said hook fasteners comprise:
a plate member formed having a substantially right angle configuration and operatively connected to suspend from the base of the respective links of the bifurcated section of said chain link member.

8. A device for lifting a standing beverage keg to a raised position, the beverage keg being substantially cylindrical in form and having hand hold openings around the upper rim thereof, comprising:
a support frame formed to fit about and partially surround the beverage keg forward of the support frame, said support frame being constructed of orthogonal members including a pair of post members spaced apart and erected in respective upright positions, a pair of base beam members each perpendicularly assembled and attached to the bottom of a respective one of said post members, said base beam members each being disposed having forward extensions from the bottom of said post members, and a pair of transverse beam members perpendicularly assembled between said post members and spaced apart in elevation thereon, the upper transverse beam being adapted to provide a hinge point;
a lever member pivotally connected to said support frame at the hinge point thereon, said lever member having a working end positioned forward of the hinge point and a handle end positioned rearward of the hinge point;
bifurcated hook means suspended from the working end of said lever member and adapted to engage the hand hold openings for applying clamping pressure to the upper rim of the beverage keg through the hand hold openings while the beverage keg is lifted to the raised position; and
link means connected upon said support frame and releasably engaged along the handle end of said lever member for maintaining the beverage keg in the raised position.

9. A keg lifting device according to claim 8, wherein said bifurcated hook means comprises:
a bifurcated chain link member connected to the working end of said lever member and suspended therefrom; and
a pair of hook fasteners connected to the base of said bifurcated chain link member, said hook fasteners being sized to fit and shaped to engage the hand hold openings on the upper rim of the beverage keg.

10. A keg lifting device according to claim 9, wherein said bifurcated chain link member comprises:
a linear section coupled at the upper end thereof to said lever member and adapted to hang therefrom; and
a bifurcated section of separate links assembled together and connected to the lower end of said linear section to suspend freely therefrom.

11. A keg lifting device according to claim 10, wherein each of said hook fasteners comprise:
a plate member formed having a substantially right angle configuration and operatively connected to suspend from the base of the respective links of the bifurcated section of said chain link member.

12. A keg lifting device according to claim 8, wherein said link means comprises:
a length of chain link secured at one end thereof to the lower transverse frame and releasably fastened at the other end along the handle end of said lever member for holding said lever member in a fixed attitude upon lifting the beverage keg to the raised position.

13. A system for handling a standard beverage keg having hand hold openings located around the top rim of the keg and a circular cavity formed at the bottom thereof, comprising:
means for lifting the beverage keg into a raised position with clamping pressure applied to the hand hold openings; and
dolly means adapted to engage the circular cavity at the bottom of the keg for transporting the keg when lowered thereon from the raised position.

14. A keg handling system according to claim 13, wherein said lifting means comprises:
a support frame formed to fit about and partially surround the beverage keg forward of the support frame;
a lever member pivotally connected to said support frame at a hinge point elevated thereon, said lever member having a working end positioned forward of the hinge point over the beverage keg and a handle end positioned rearward of the hinge point; and
bifurcated hook means suspended from the working end of said lever member and adapted to engage the hand hold openings for applying clamping pressure upon the upper rim of the beverage keg through the hand hold openings while the beverage keg is lifted to the raised position; and
link means connected upon said support frame and releasably engaged along the handle end of said lever member for maintaining the beverage keg in the raised position.

15. A keg handling system according to claim 14, wherein said support frame is formed of orthogonal members comprising:
a pair of post members spaced apart and erected in respective upright positions;
a pair of base beam members each perpendicularly assembled and attached to the bottom of a respective one of said post members, said base beam members each being disposed having forward extensions from the bottom of said post members; and
a pair of transverse beam members perpendicularly assembled between said post members and spaced apart in elevation thereon, the upper transverse beam being adapted to provide the hinge point for said lever member.

16. A keg handling system according to claim 14, wherein said bifurcated hook means comprises:
a bifurcated chain link member connected to the working end of said lever member and suspended therefrom; and
a pair of hook fasteners connected to the base of said bifurcated chain link member, said hook fasteners being sized to fit and shaped to engage the hand hold openings on the upper rim of the beverage keg.

17. A keg handling system according to claim 16, wherein said bifurcated chain link member comprises:
a linear section coupled at the upper end thereof to said lever member and adapted to hang therefrom; and
a bifurcated section of separate links assembled together and connected to the lower end of said linear section to suspend freely therefrom.

18. A keg handling system according to claim 17, wherein each of said hook fasteners comprise:
a plate member formed having a substantially right angle configuration and operatively connected to suspend from the base of the respective links of the bifurcated section of said chain link member.

19. A keg handling system according to claim 13, wherein said dolly means comprises:
a base platform having a flat upper surface;
a pad member disposed centrally upon the upper surface of said base platform and attached thereto to provide a raised surface layer thereon, said pad being formed to fit the circular cavity at the bottom of the beverage keg and provide seated engagement between the dolly means and the beverage keg lowered thereon; and
a plurality of casters secured to the bottom of the base platform and spaced apart radially around the perimeter thereof.

20. A keg handling system according to claim 19, wherein said pad member is circular in configuration.
